(19) United States
(12) Patent Application Publication
(10) Pub. No.: US 2007/0180769 A1
(43) Pub. Date: Aug. 9, 2007

(54) Fuel reformer having closed loop control of air/fuel ratio

(76) Inventors: Joseph V. Bonadies, Clarkston, MI (US); Russell H. Bosch, Gaines, MI (US)

Correspondence Address: Paul L. Marshall, Esq.;Delphi Technologies, Inc., Mail Code 480410202, P.O. Box 5052, Troy, MI, 48007, US

(21) Appl. No.: 11/350,346

(22) Filed: Feb. 8, 2006

(51) Int. Cl. C01B 3/32

(52) U.S. Cl. 48/198.7; 48/127.9

(57) ABSTRACT

A reformer system comprising a conventional hydrocarbon reformer; a controllable fuel supply system; a controllable air supply system; an oxygen sensor disposed downstream of the reformer; and control means for receiving input from the oxygen sensor and setting the flow values for fuel and air. During start-up of the reformer, air and fuel are mixed in a stoichiometric ratio, typically about 14.5/1 A/F for a typical alkane fuel, the heat of combustion being maximum at the stoichiometric ratio. The mixture is combusted ahead of the reformer for typically about 20 seconds, and the hot exhaust is passed through the reformer. After the combustion event, combustion is terminated and the A/F ratio is lowered to about 5/1 to allow reforming to occur. Once the desired fuel flow rate for combustion is established it can be stored in computer memory as a starting value for subsequent starting events.

### TECHNICAL FIELD

The present invention relates to reformers for catalytically converting hydrocarbons into hydrogen-containing reformate for use in a fuel cell; more particularly, to methods and apparatus for controlling the ratio of air to fuel during various phases of reformer operation; and most particularly, to a method and apparatus for controlling the air/fuel ratio by measuring the oxygen level in the reformer exhaust stream and feeding back such measurement to a fuel and air supply controller in a closed-loop mode.

### BACKGROUND OF THE INVENTION

Catalytic reformers for converting hydrocarbons (referred to herein as “fuel”) and air to reformate are well known, air being a ready source of oxygen for the reforming process in exothermic mode. Such reformate typically comprises hydrogen, carbon monoxide, nitrogen, and residual hydrocarbons. The flow rates of fuel and air typically are monitored and controlled by electronic control means, such as a programmable controller or a computer.

In the prior art, the desired fuel flow rate is calculated in open-loop control based upon the measured mass air flow rate at the inlet to the system and a resultant base pulse width of a fuel injector. There is no feedback control derived from the degree of accuracy of the resultant air-to-fuel (ANF) ratio. The actual A/F ratio delivered to the reformer catalyst is not known but rather is inferred from the measured inlet air mass flow rate and the expected fuel mass flow rate from the fuel injector. Because of variations in production hardware, the air and fuel control setpoints have associated errors that can result in poor combustion and excess fuel deposition on the interior walls of the reformer during a start-up combustion phase.

Further, prior art reformer controls also monitor the inlet and outlet temperatures of the reformer catalyst during both the combustion warm-up phase and steady-state operation. If either the inlet or outlet temperature exceeds a calibratable threshold, the reformer is shut down and the start-up sequence must be re-initiated. As a result, excess fuel may be deposited on the interior surfaces of the reformer, leading to carbon formation and errant fuel control as the fuel puddle evaporates of pyrolizes over time.

What is needed in the art is an improved means for maintaining at a desired value the ratio of air to fuel being supplied to a hydrocarbon reformer.

What is further needed is such a means wherein a non-intended air/fuel mixture is detected and corrected before an unintended and undesirable thermal excursion occurs.

It is a principal object of the present invention to control the ratio of air to fuel being supplied to a hydrocarbon reformer at a predetermined ratio.

### SUMMARY OF THE INVENTION

Briefly described, a reformer system in accordance with the invention comprises a conventional hydrocarbon reformer; a controllable fuel supply system; a controllable air supply system; an oxygen sensor disposed downstream of the reformer; and a control means for receiving input from the oxygen sensor and setting the flow values for fuel and air.

During start-up of the reformer, air and fuel are mixed in about a stoichiometric ratio, typically 14.5/1 A/F for a typical alkane fuel, and the AF mixture is combusted ahead of the reformer for typically about 20 seconds, the hot exhaust being passed through the reformer to heat the walls and catalyst. The heat of combustion is maximum at the stoichiometric ratio. After the combustion event, combustion is terminated and the A/F ratio is lowered to, typically, about 5/1 to allow reforming to occur.

Once the desired fuel flow rate for combustion is established it can be stored in computer memory as a starting value for subsequent starting events.

### BRIEF DESCRIPTION OF THE DRAWINGS

The present invention will now be described, by way of example, with reference to the accompanying drawings, in which:

FIG. 1 is a schematic drawing of a prior art open-loop control system for regulating flows of air and fuel into a hydrocarbon reformer;

FIG. 2 is a schematic drawing of a closed-loop control system in accordance with the invention for regulating flows of air and fuel into a hydrocarbon reformer;

FIG. 3 is a first algorithm for a switching-type oxygen sensor for use in the schematic drawing shown in FIG. 2; and

FIG. 4 is a second algorithm for a wide range oxygen sensor for use in the schematic drawing shown in FIG. 2.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

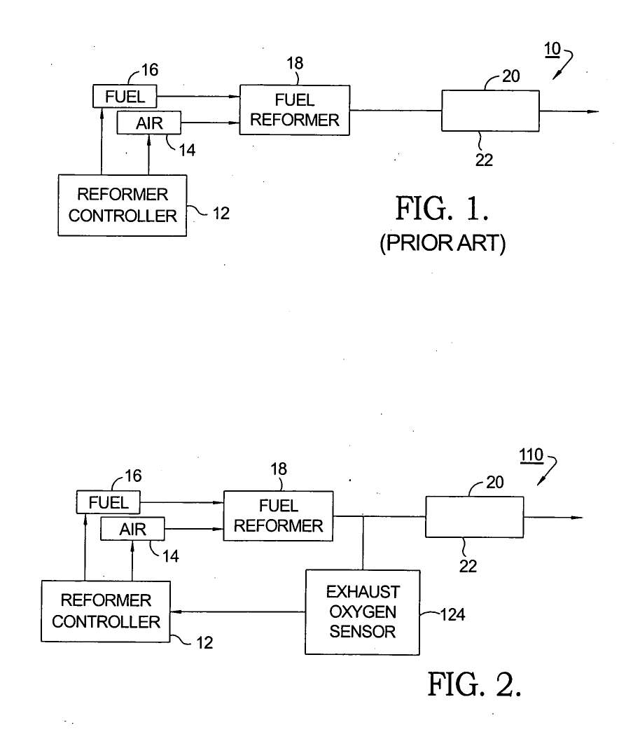

Referring to FIG. 1, a prior art open-loop control system 10 includes a reformer controller 12 that regulates flows of air 14 and fuel 16 into a hydrocarbon reformer 18 to produce a reformer exhaust 20. During a combustion phase at start-up, the ANF mixture is burned ahead of reformer 18 and passed through the reformer. In this phase, reformer exhaust 20 is not reformate and comprises principally carbon dioxide (CO₂), oxygen (O₂), and water (H₂O). After reformer 18 is heated to a sufficient temperature, combustion is terminated, the A/F ratio is adjusted to a much richer fuel mixture, and reforming begins, producing a reformate 22 containing hydrogen (H₂), carbon monoxide (CO), residual hydrocarbons (HC), and nitrogen (N₂). The control settings for pumps or other means supplying air and fuel are predetermined and are programmed into the reformer controller, and are based upon expected delivery curves for such means. As noted above, prior art system 12 cannot compensate for errors in flow and therefore cannot closely control the A/F ratio. This is especially critical during the start-up phase wherein the presence of excess fuel can lead to carbonizing (soot) of the reform walls and catalyst.

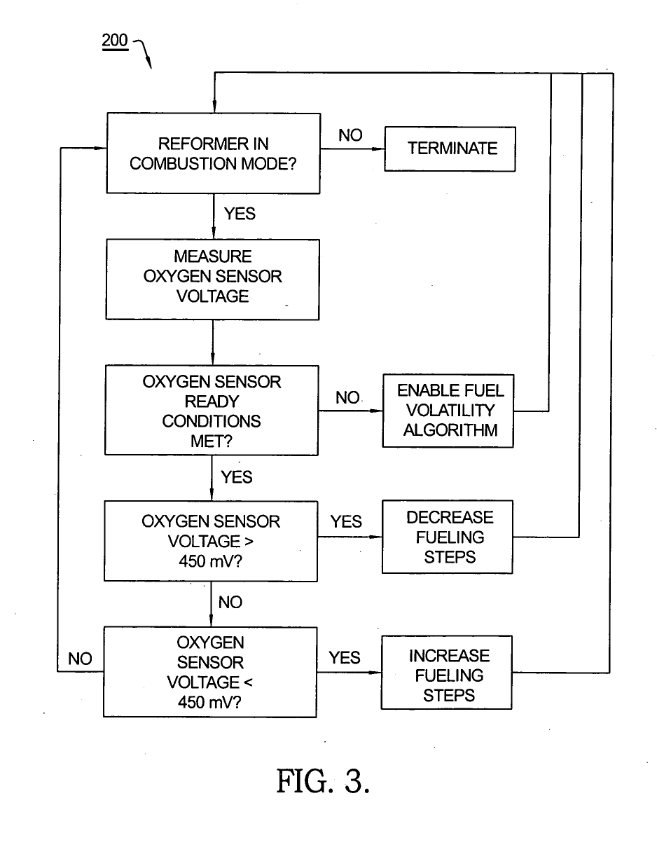

Referring to FIG. 2, improved closed-loop control system 110, like prior art open-loop control system 10, includes a reformer controller 12 that regulates flows of air 14 and fuel 16 into a hydrocarbon reformer 18 to produce a reformer exhaust 20. In addition, system 110 includes oxygen sensing means 124 which preferably is disposed downstream of reformer 18 to sense oxygen levels in effluent therefrom. In a presently preferred method in accordance with the invention, oxygen sensing means 124 is active only during the combustion phase of reformer operation at start up, when the fuel flow can be trimmed to keep the A/F ratio at the desired value. Once the desired fuel flow has been reached, the fuel flow value can be stored in the computer and used as-a starting point for fuel flow for the next reformer starting (combustion) event.

Oxygen sensing means 124 may readily employ a prior art automotive exhaust oxygen sensor such as is widely used in all vehicles manufactured today as part of emissions control systems. Such sensors are well suited to measuring oxygen levels in an exhaust stream from a catalytic hydrocarbon reformer.

It is preferable to locate the exhaust oxygen sensor downstream of the reforming catalyst to permit better mixing and equilibration of the oxidation reaction, resulting in a more accurate measure of free oxygen in the reformer exhaust. A heated-type sensor should be located at a point in the reformer exhaust that will not exceed the maximum allowable temperature for the sensor, typically about 900° C. A non-heated type sensor should be located such that the minimum temperature exceeds about 260° C., with periodic excursions above 450° C. to oxidize any soot deposits that may occur.

A heated-type oxygen sensor typically requires approximately 10 seconds of heating to become active for measuring oxygen. This pre-heating period can be built into the reformer start-up algorithm such that the sensor is heated by an electrical resistance heater prior to beginning the combustion event. An advantage of activating the oxygen sensor prior to the combustion event is that less or no time is then spent in a functional open-loop control at the start of combustion wherein the actual A/F ratio is not measured. It is also possible to use the output from the oxygen sensor before it is completely active to determine the fuel volatility and to correct the fuel flow rate to improve the combustion process, as described in U.S. Pat. Nos. 6,925,861 and 6,938,466, the relevant disclosure of which is incorporated herein by reference.

Oxygen sensors in common use in the prior automotive art fall generally into two categories: switching type and wide range.

Referring to FIG. 3, a first algorithm 200 is shown for controlling fuel flow to a reformer during a combustion phase, using a switching-type oxygen sensor. At the start-up, if the reformer is not in combustion mode, the program is terminated; that is, this exemplary use of an oxygen sensor is shown for control of A/F ratio during the combustion phase for warming the reformer at start-up. Obviously, the disclosed system may also be used for A/F mixture control during reforming within the measurement range of the specific oxygen sensor. The method for controlling air/fuel ratio to the reformer, using a switching-type oxygen sensor, is as follows. If combustion mode is indicated, measure the voltage output of the oxygen sensor against predetermined ready conditions. If the ready conditions are not met, abort the use of the oxygen sensor and alternatively proceed with a fuel volatility algorithm as described in the incorporated reference. If ready conditions are met, determine if the output voltage is 450 mv, which value corresponds to the correct residual oxygen value in the combustion exhaust of an optimal near-stoichiometric mixture of air and fuel. If the sensor output is greater than 450 mV, decrease the fueling rate to make the combustion mixture leaner in fuel. If the sensor output is less than 450 mV, increase the fueling rate to make the combustion mixture richer in fuel. If the sensor output is neither less than nor greater than 450 mV, within a calibratable range of +/−20 mV, for example, make no adjustments in fueling rate.

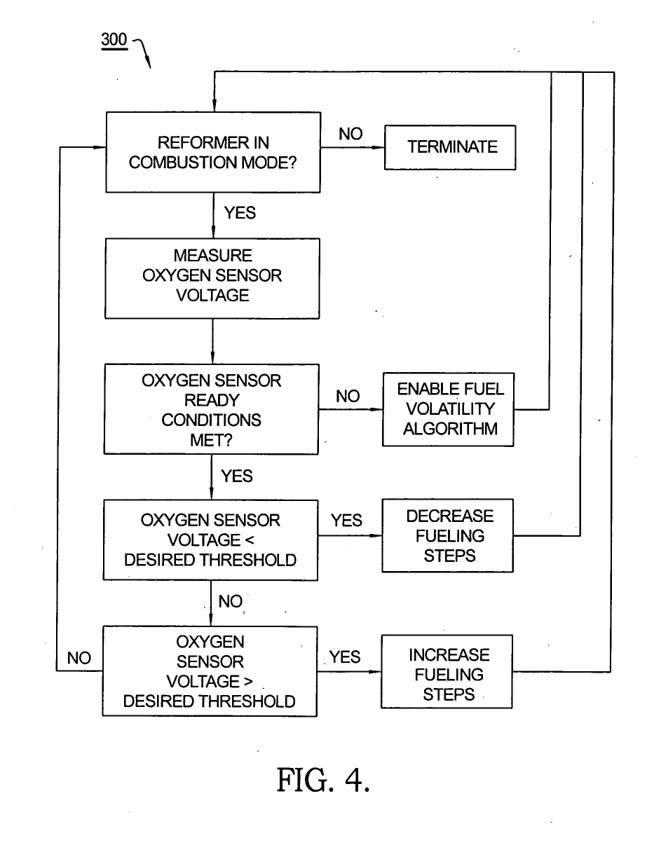

Referring to FIG. 4, a second algorithm 300 is shown for controlling fuel flow to a reformer during a combustion phase, using a wide range oxygen sensor. Second algorithm 300 is identical to first algorithm 100 in all respects except for the sensor control criterion, which is whether or not the sensor output is above or below a predetermined threshold value, as shown in FIG. 4.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for closed-loop control of air/fuel ratio in an air/fuel mixture being supplied to a hydrocarbon reformer, comprising:
a) a controllable fuel supply system connected to said reformer;
b) a controllable air supply system connected to said reformer;
c) an oxygen sensor disposed downstream of said hydrocarbon reformer; and
d) a controller connected to said fuel supply system, to said air supply system, and to said oxygen sensor for receiving input from said oxygen sensor and setting flow values for fuel and air to provide a predetermined air/fuel ratio.

2. A system in accordance with claim 1 wherein said predetermined air/fuel ratio is suitable for combustion of said air/fuel mixture.

3. A system in accordance with claim 2 wherein said ratio is about 14.5/1.

4. A system in accordance with claim 1 wherein said predetermined air/fuel ratio is suitable for reforming of said air/fuel mixture.

5. A system in accordance with claim 4 wherein said ratio is about 5/1.

6. A system in accordance with claim 1 wherein said oxygen sensor is suitable as an oxygen sensor in the exhaust stream of an internal combustion engine.

7. A system in accordance with claim 1 wherein said oxygen sensor is selected from the group consisting of switching type and wide range type.

8. A reformer system for catalytically reforming hydrocarbons to provide reformate, comprising:
a) a reformer;
b) a controllable fuel supply system connected to said reformer;
c) a controllable air supply system connected to said reformer;
d) an oxygen sensor disposed downstream of said hydrocarbon reformer; and
e) a controller connected to said fuel supply system, to said air supply system, and to said oxygen sensor for receiving input from said oxygen sensor and setting flow values for fuel and air to provide a predetermined air/fuel ratio to said reformer.

9. A method for closed-loop control of air/fuel ratio in an air/fuel mixture being supplied to a hydrocarbon reformer, comprising the steps of:
a) providing a controllable fuel supply system and a controllable air supply system connected to said hydrocarbon reformer;
b) providing an oxygen sensor disposed downstream of said hydrocarbon reformer;
c) providing a controller connected to said oxygen sensor and to at least one of said fuel supply system or said air supply system;
d) setting at least one of an air flow rate or a fuel flow rate to form a first air/fuel mixture having a first air/fuel ratio;
e) combusting said first air/fuel mixture to form a hot combustion exhaust;
f) passing said combustion exhaust past said oxygen sensor, and sending a signal from said oxygen sensor to said controller indicative of oxygen level in said exhaust; and
g) sending a signal from said controller to adjust at least one of said air flow rate or said fuel flow rate to form a second air/fuel mixture having a second air/fuel ratio.

10. A method in accordance with claim 9 wherein said second air/fuel ratio is closer to a desired air/fuel ratio than is said first air/fuel ratio.

11. A method in accordance with claim 10 wherein said desired air/fuel ratio is about 14.5/1.

12. A method in accordance with claim 9 comprising iteration of steps d) through g) to generate additional air/fuel ratios successively closer to a desired air/fuel ratio.
